(19) United States
(12) Patent Application Publication
(10) Pub. No.: US 2014/0359378 A1
(43) Pub. Date: Dec. 4, 2014

(54) SYSTEM AND METHOD FOR DETECTING STATUS INFORMATION OF MOTHERBOARD OF SERVER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: JIN-YAN SUN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/178,170

(22) Filed: Feb. 11, 2014

(30) Foreign Application Priority Data
Jun. 4, 2013 (CN) 2013102182584

(51) Int. Cl. G06F 11/07

(52) U.S. Cl. CPC G06F 11/0769
USPC 714/57

(57) ABSTRACT

A system for detecting status information of a motherboard, a plurality of operating units being located on the motherboard, and each of the plurality of operating units being adapted to generate an error message when each of the plurality of operating units becomes abnormal, the system includes a detecting module, and an information display card. The detecting module is adapted to query address information corresponding to abnormal operating unit according to the error message. The information display card comprises a controlling module and a display module connected to the controlling module. The controlling module is adapted to obtain the address information and the abnormal operating unit, and the controlling module further adapted to control the display module to display the address information and the abnormal operating unit.

### FIELD

The present disclosure relates to systems and methods for detecting status information of a motherboard of a server.

### BACKGROUND

Server functions continue to become more complex. Often when one unit in a server, such as CPU, graphic card or power supply, for example, in the server becomes abnormal, the system of the server must be shut down, and all components in the server have to be tested to find the abnormal unit, which is time consuming and inefficient.

### BRIEF DESCRIPTION OF THE DRAWINGS

Many aspects of the embodiments within this disclosure can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a system for detecting status information of motherboard.

FIG. 2 is a flowchart showing one embodiment of a method for detecting status information of motherboard.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and that such references mean at least one.

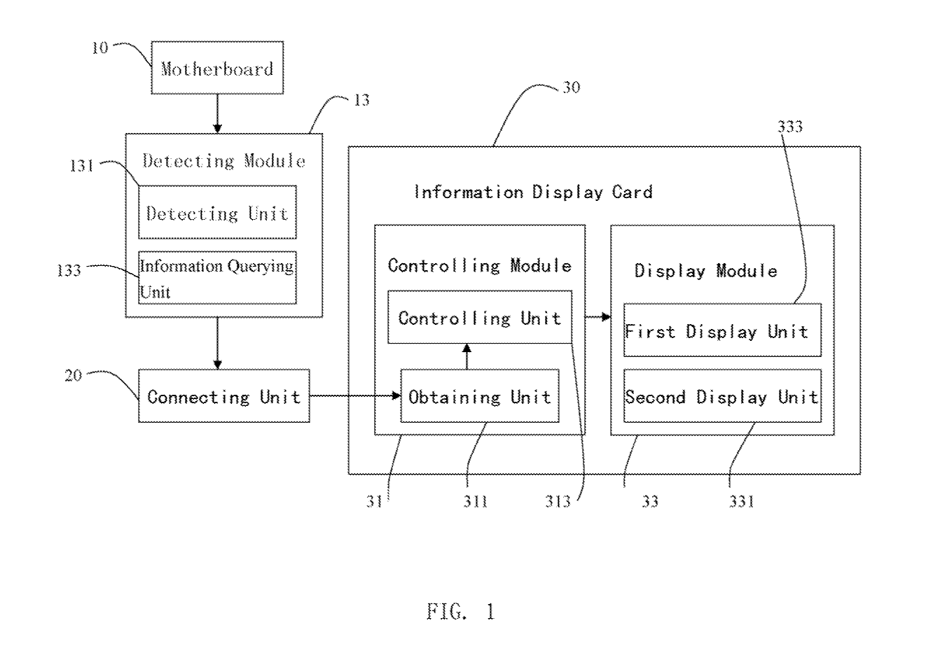

FIG. 1 shows one embodiment of a system for detecting status information of a motherboard 10. The system includes a detecting module 13, a connecting unit 20, and an information display card 30. In one embodiment, the connecting unit 30 is a connector. A plurality of operating units is located on the motherboard 10. The operating unit may be a CPU, a graphic card, a power supply, for example. When one of the plurality of operating units becomes abnormal, the power supply will not work normally, and each of the plurality of operating units may generate an error message. The detecting module 13 is electrically connected to the motherboard 10 and is adapted to detect the error message. The connecting unit 20 is connected to the detecting module 13 and to the information display card 30. The information display card 30 is adapted to obtain the address information of the abnormal operating unit, and further adapted to display the address information and of abnormal operating unit.

The detecting module 13 includes a detecting unit 131, and an information querying unit 133. The detecting unit 131 rear-time detects the error message. The information querying unit 133 queries address information of the abnormal operating unit according to the error message from a table holding all information of the plurality of operating units when the detecting unit 131 receives the error message. In one embodiment, the detecting module 13 may be a complex programmable logic device (CPLD) or field-programmable gate array (FPGA).

The information display card 30 includes a controlling module 31 and a display module 33. The controlling module 31 includes an obtaining unit 311 and a controlling unit 313. The obtaining unit 311 is connected to the connecting unit 20 and obtains the address of the abnormal operating unit. The display module 33 includes a first display unit 331 and a second display unit 333. The first display unit 331 includes eight light emitting diodes (LED). The second display unit 333 is a liquid crystal display (LCD). In one embodiment, the controlling module 31 can be a complex programmable logic device (CPLD) or field-programmable gate array (FPGA). The controlling unit 313 can be adapted to turn on or off the light emitting diodes (LED) to display the address information of the abnormal operating unit. The controlling unit 313 is adapted to control the second display unit 333 to display the address information of the abnormal operating unit.

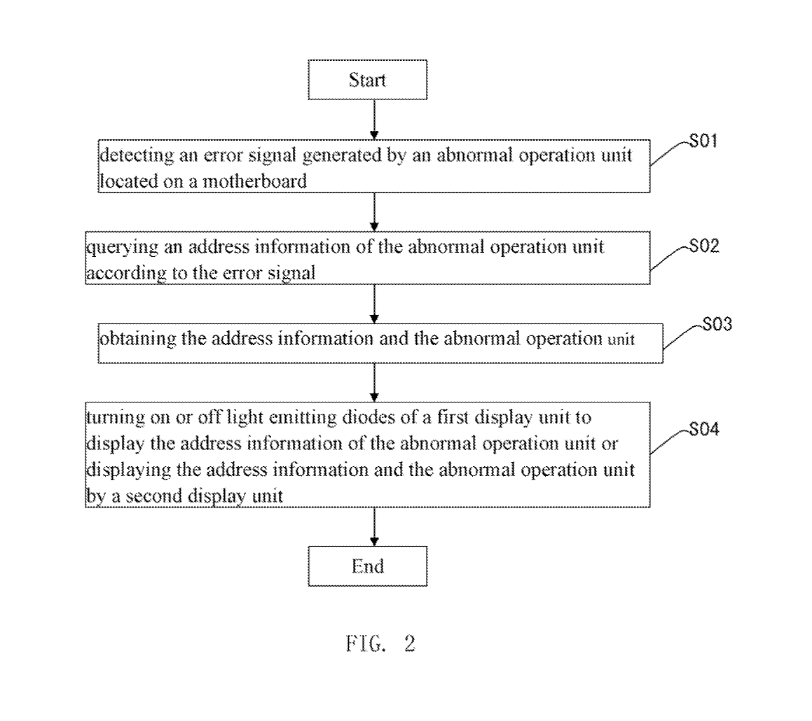

FIG. 2 is a flowchart showing one embodiment of a method for detecting status information of the motherboard 10. The method comprises the following steps.

In step S01, the detecting unit 131 rear-time detects the error message.

In step S02, the information querying unit 133 queries address information of the abnormal operating unit according to the error message from a table containing all information of the plurality of operating units.

In step S03, the obtaining unit 311 obtains the address information of the abnormal operating unit.

In step S04, the controlling unit 313 turns on or off the light emitting diodes (LED) to display the address information of the abnormal operating unit or controls the second display unit 333 to display the address information of the abnormal operating unit.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A system for detecting status information of a motherboard, a plurality of operating units being located on the motherboard, and each of the plurality of operating units being adapted to generate an error message when each of the plurality of operating units operates abnormally, the system comprising:
a detecting module adapted to query an address information corresponding to abnormal operating unit according to the error message; and
an information display card comprising a controlling module and a display module connected to the controlling module,
wherein the controlling module is adapted to obtain the address information of the abnormal operating unit, and the controlling module is further adapted to control the display module to display the address information of the abnormal operating unit.

2. The system of claim 1, further comprising a connecting module, wherein the connecting module is connected to the detecting module and the controlling module.

3. The system of claim 1, wherein the detecting module comprises a detecting unit, and the detecting unit is adapted to detect the error message.

4. The system of claim 3, wherein the detecting module further comprises an information querying unit, and the information querying unit is adapted to query the address information from a table with the address information of the plurality of operating unit.

5. The system of claim 1, wherein the controlling module comprises an obtaining unit, and the obtaining unit is adapted to obtain the address information corresponding to the error message.

6. The system of claim 5, wherein the controlling module comprises a controlling unit, the display module comprises a first display unit, and the controlling unit is adapted to turn on the first display unit to show the address information.

7. The system of claim 6, wherein the first display unit comprises eight light emitting diodes.

8. The system of claim 6, wherein the display module comprises a second display unit, and the second display unit is adapted to display the address information.

9. A method for detecting status information of a motherboard, a plurality of operating units being located on the motherboard, and each of the plurality of operating units being adapted to generate an error message when each of the plurality of operating units operates abnormally, the method comprising:
querying address information corresponding to an abnormal operating unit according to the error message; and
obtaining the error message and the address information, and
displaying the address information of the abnormal operating unit.

10. The method of claim 9, further comprising:
detecting the error message.

11. The method of claim 9, further comprising:
turning on the light emitting diodes to show the address information.

12. The method of claim 9, further comprising:
displaying the address information of the abnormal operating unit on a liquid crystal display.
